(19) United States
(12) Patent Application Publication
(10) Pub. No.: US 2008/0039320 A1
(43) Pub. Date: Feb. 14, 2008

(54) Use Of Menadione

(76) Inventors: Harald Kohle, Bobenheim (DE); Reinhard Stierl, Freinsheim (DE); Randall Evan Gold, Obrigheim (DE); Felix Christian Gorth, Ludwigshafen (DE); John-Bryan Speakman, Bobenheim (DE); Peter Dombo, Wiesbaden (DE); Martin Semar, Gleiszellen-Gleishorbach (DE); Dieter Strobel, Herxheim am Berg (DE); Matthias Niedenbruck, Limburgerhof (DE); Hans Bestman, Neustadt/Weinstrasse (DE)

Correspondence Address: HUTCHISON LAW GROUP PLLC, PO BOX 31686, RALEIGH, NC, 27612, US

(21) Appl. No.: 11/791,464

(22) PCT Filed: Nov. 24, 2005
(86) PCT No.: PCT/EP05/12562

§ 371 Date: May 23, 2007

(30) Foreign Application Priority Data
Nov. 26, 2004 (DE) 102004057279.8

(51) Int. Cl. A01N 35/06; A01C 1/06; A01N 43/40; A01N 43/56; A01N 43/84; A01P 3/00; A01N 43/653; A01N 43/50; A01N 25/00

(52) U.S. Cl. 504/100; 514/237.5; 514/355; 514/383; 514/389; 514/407; 514/687; 514/772

(57) ABSTRACT

The use of menadione or one of its plant-compatible acid addition salts for enhancing the activity of agrochemicals against phytopathogenic fungi, mixtures of menadione and at least one active compound selected from the following groups: A) azoles, such as cyproconazole, difenoconazole, epoxiconazole, fluquinconazole, flusilazole, hexaconazole, imazalil, metconazole, myclobutanil, penconazole, prochloraz, prothioconazole, tebuconazole, triadimefon, triadimenol, triflumizole; B) strobilurins, such as azoxystrobin, dimoxystrobin, fluoxastrobin, kresoxim-methyl, metominostrobin, orysastrobin, picoxystrobin, pyraclostrobin or trifloxystrobin; C) acylalanines, such as benalaxyl, metalaxyl, mefenoxam, ofurace, oxadixyl; D) amine derivatives, such as spiroxamine; E) anilinopyrimidines, such as pyrimethanil, mepanipyrim or cyprodinil; F) dicarboximides, such as iprodione, procymidone, vinclozolin; G) cinnamides and analogs, such as dimethomorph, flumetover or flumorph; H) dithiocarbamates, such as ferbam, nabam, maneb, metam, metiram, propineb, polycarbamate, thiram, ziram, zineb; I) heterocylic compounds, such as benomyl, boscalid, carbendazim, dithianon, famoxadone, fenamidone, picobenzamid, proquinazid, quinoxyfen, thiophanate-methyl, triforine, 5-chloro-7-(4-methylpiperidin-1-yl)-6-(2,4,6-trifluorophenyl)-[1,2,4]triazolo[1,5-a]pyrimidine, N,N-dimethyl-3-(3-bromo-6-fluoro-2-methylindole-1-sulfonyl)-[1,2,4]triazole-1-sulfonamide or thiophene derivatives of the formula II; K) sulfur and copper fungicides, such as Bordeaux mixture, copper acetate, copper oxychloride, basic copper sulfate; L) nitrophenyl derivatives, such as dinocap; M) phenylpyrroles, such as fenpiclonil or fludioxonil; N) sulfenic acid derivatives, such as captafol, dichlofluanid, tolylfluanid; 0) other fungicides selected from the group consisting of benthiavalicarb, chlorothalonil, cyflufenamid, diclofluanid, diethofencarb, ethaboxam, fenhexamid, fluazinam, iprovalicarb, metrafenone, zoxamide; oxime ether derivatives of the formula III, phenylamidine derivatives of the formula IV, compounds of the formula V, where in the formulae III to V the substituents are defined according to the description; in a synergistically effective amount, methods for controlling harmful fungi using mixtures of menadione with active compounds from groups A) to O) and compositions comprising these mixtures.

The present invention relates to the use of menadione of the formula I

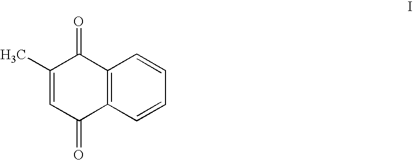

or one of its plant-compatible acid addition salts for enhancing the activity of agro-chemicals against phytopathogenic fungi.

In particular, the invention relates to active compound combinations comprising, as active components,

1) menadione of the formula I,

and

2) at least one active compound II selected from the following groups:
A) azoles, such as cyproconazole, difenoconazole, epoxiconazole, fluquinconazole, flusilazole, hexaconazole, imazalil, metconazole, myclobutanil, penconazole, prochloraz, prothioconazole, tebuconazole, triadimefon, triadimenol, triflumizole;
B) strobilurins, such as azoxystrobin, dimoxystrobin, fluoxastrobin, kresoxim-methyl, metominostrobin, orysastrobin, picoxystrobin, pyraclostrobin, tri-floxystrobin or methyl 2-(ortho-((2,5-dimethylphenyloxymethylene)phenyl)-3-methoxyacrylate;
C) acylalanines, such as benalaxyl, metalaxyl, mefenoxam, ofurace, oxadixyl;
D) amine derivatives, such as spiroxamine;
E) anilinopyrimidines, such as pyrimethanil, mepanipyrim or cyprodinil;
F) dicarboximides, such as iprodione, procymidone, vinclozolin;
G) cinnamides and analogs, such as dimethomorph, flumetover or flumorph;
H) dithiocarbamates, such as ferbam, nabam, maneb, metam, metiram, propineb, polycarbamate, thiram, ziram, zineb;
I) heterocylic compounds, such as benomyl, boscalid, carbendazim, dithianon, famoxadone, fenamidone, picobenzamid, proquinazid, quinoxyfen, thiophanate-methyl, triforine, N-(4′-bromobiphenyl-2-yl)-(4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide or
   5-chloro-7-(4-methylpiperidin-1-yl)-6-(2,4,6-trifluorophenyl)-[1,2,4]triazolo[1,5-a]pyrimidine,
   thiophene derivatives of the formula II-A, 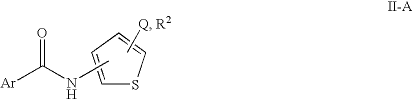
   in which the variables are as defined below:
   Ar is phenyl or a five- or six-membered aromatic heterocycle which contains one to four heteroatoms from the group consisting of O, N and S, where the cycles may be unsubstituted or substituted by one to three groups R²¹:
      R²¹ is halogen, C₁-C₄-alkyl or C₁-C₄-haloalkyl;
   R² is phenyl, C₁-C₈-alkyl, C₁-C₈-haloalkyl, C₁-C₈-alkoxy, C₁-C₈-haloalkoxy;
   Q is hydrogen, C₁-C₈-alkyl, C₁-C₈-haloalkyl, C₁-C₈-alkoxy, C₁-C₈-haloalkoxy;
K) sulfur and copper fungicides, such as Bordeaux mixture, copper acetate, copper oxychloride, basic copper sulfate;
L) nitrophenyl derivatives, such as dinocap;
M) phenylpyrroles, such as fenpiclonil or fludioxonil;
N) sulfenic acid derivatives, such as captafol, dichlofluanid, tolylfluanid;
O) other fungicides selected from the group consisting of benthiavalicarb, chlorothalonil, cyflufenamid, diclofluanid, diethofencarb, ethaboxam, fenhexamid, fluazinam, iprovalicarb, mandipropamid, metrafenone, zoxamide;
   oxime ether derivatives of the formula III, 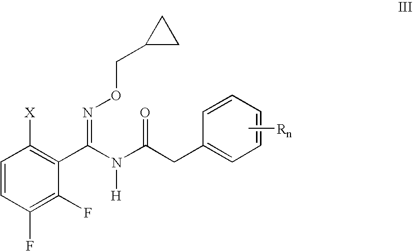
   in which
   X is C₁-C₄-haloalkoxy,
   n is 0, 1, 2 or 3,
   R is halogen, C₁-C₄-alkyl, C₁-C₄-haloalkyl, C₁-C₄-alkoxy or haloalkoxy; and
   phenylamidine derivatives of the formula IV, 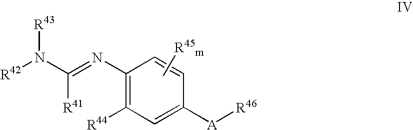
   in which the variables are as defined below:
   R⁴¹ is hydrogen, C₁-C₈-alkyl, C₂-C₈-alkenyl or C₂-C₈-alkynyl which are unsubstituted or may be substituted by one to three groups R^{a}:
      R^{a} is halogen, C₁-C₈-alkoxy, C₁-C₈-haloalkoxy, C₁-C₈-alkylthio or phenyl which may be substituted by halogen, C₁-C₈-alkyl, C₁-C₈-haloalkyl, C₁-C₈-alkoxy, C₁-C₈-haloalkoxy or C₁-C₈-alkylthio;
   R⁴², R⁴³ may be identical or different and are hydrogen, cyano, C₁-C₈-alkyl, C₂-C₈-alkenyl, C₂-C₈-alkynyl, C₁-C₈-alkoxy, C₁-C₈-alkoxy-alkyl, benzyloxy or C₁-C₈-alkylcarbonyl which are unsubstituted or may be substituted by one to three groups R^{a};
   R⁴⁴ is hydrogen, C₁-C₈-alkyl, C₂-C₈-alkenyl or C₂-C₈-alkynyl which are unsubstituted or may be substituted by one to three groups R^{b}:
      R^{b} is one of the groups mentioned under R^{a}, cyano, C(═O)R^{c}, C(═S)R^{c} or S(O)ₚR^{c},
      R^{c} is C₁-C₈-alkyl, C₁-C₈-haloalkyl, C₁-C₈-alkoxy, C₁-C₈-haloalkoxy, C₁-C₈-alkylthio, amino, C₁-C₈-alkylamino, di(C₁-C₈-alkyl)amino or
      phenyl which may be substituted by halogen, C₁-C₈-alkyl, C₁-C₈-haloalkyl, C₁-C₈-alkoxy, C₁-C₈-haloalkoxy or C₁-C₈-alkylthio;
   m is 0 or 1;
   R⁴⁵ is one of the groups mentioned under R⁴⁴;
   A is a direct bond, —O—, —S—, NR^{d}, CHR^{e} or —O—CHR^{e};
      R^{d}, R^{e} are one of the groups mentioned under R^{a};
   R⁴⁶ is phenyl or a five- or six-membered saturated, partially unsaturated or aromatic heterocycle which contains one to four heteroatoms from the group consisting of O, N and S, where the groups R⁴⁶ are unsubstituted or may be substituted by one to three R^{f}:
      R^{f} is one of the groups mentioned under R^{b} or amino, C₁-C₈-alkylamino, di(C₁-C₈-alkyl)amino, C₁-C₈-haloalkyl, C₁-C₈-alkoxyalkyl, C₂-C₈-alkenyloxyalkyl, C₂-C₈-alkynyloxyalkyl, C₁-C₈-alkylcarbonyloxy-C₁-C₈-alkyl, cyanooxy-C₁-C₈-alkyl, C₃-C₆-cycloalkyl or phenoxy, where the cyclic groups may be substituted by halogen, C₁-C₈-alkyl, C₁-C₈-haloalkyl, C₁-C₈-alkoxy, C₁-C₈-haloalkoxy or C₁-C₈-alkylthio;
   compounds of the formula V 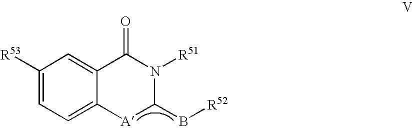
   in which the variables are as defined below:
   A′ is O or N;
   B is N or a direct bond;
   R⁵¹ is C₁-C₄-alkyl;
   R⁵² is C₁-C₄-alkoxy; and
   R⁵³ is halogen;

in a synergistically effective amount;

moreover, the invention relates to a method for controlling harmful fungi using mixtures of menadione with active compounds from groups A) to O), to compositions comprising these mixtures and to the use of menadione for enhancing the fungicidal activity of synthetic fungicides against phytopathogenic fungi.

2-methyl-1,4-naphthoquinone of the formula I is generally known as menadione or vitamin K3 [cf.: http://www.awt-feedadditives.de/fileadmin/awt/pdf/AWT-Statement-Vitamin_K3_Menadion_.pdf]. It is an established additive for the diet of humans and animals; in the pharmaceutical field, it is known as a synergist for antibiotics and anti-mycotids (WO 00/006143; WO 82/01821), but it is also known as a biocide against the growth of microorganisms (WO 01/028328) and, in crop protection, as a safener (WO 03/105 586). In addition, it has been described as a plant-invigorating agent [cf.: A. A. Borges, H. J. Cools and J. A. Lucas, Plant Pathology Vol. 52 (4), p. 429ff (2003)].

With a view to lowering the application rates of agrochemicals in crop protection and to widening the activity spectrum of the known active compounds, it was an object of the present invention to provide mixtures which, at a reduced total amount of active compounds applied, have improved action against phytopathogenic harmful fungi.

Accordingly, we have found that, although menadione for its part does have no fungicidal action against phytopathogenic fungi, it acts as a synergist for fungicidal agrochemicals. Fungicidal agrochemicals suitable for the purpose of the present invention are in particular the active compounds mentioned above in groups A) to O).

Furthermore, we have found the mixtures defined above. Moreover, we have found that simultaneous joint or separate application of menadione and an active compound II from groups A) to O) or successive application of menadione and an active compound from groups A) to O) allows better control of phytopathogenic harmful fungi than the respective active compounds from group A) to O) on their own (synergistic mixtures).

By mixing menadione with the other fungicidal active compound from groups A) to O) as premix or as tank mix, the application rate of agrochemicals required for achieving the desired fungicidal action can be reduced noticeably.

The mixtures of menadione and at least one active compound from groups A) to O) or the simultaneous joint or separate use of menadione and an active compound from groups A) to O) are/is distinguished by excellent activity against a broad spectrum of phytopathogenic fungi, in particular from the classes of the Ascomycetes, Deuteromycetes, Oomycetes and Basidiomycetes. They can be used in crop protection as foliar fungicides, as fungicides for seed dressing and as soil fungicides.

They are particularly important in the control of a multitude of fungi on various cultivated plants, such as bananas, cotton, vegetables (e.g. cucumbers, beans and cucurbits), barley, grass, oats, coffee, potatoes, corn, fruit, rice, rye, soybeans, tomatoes, grape vines, wheat, ornamental plants, sugar cane and a multiplicity of seeds.

They are especially suitable for controlling the following plant diseases:
Alternaria species on vegetables, rapeseed, sugar beet and fruit and rice,
Aphanomyces species on sugar beet and vegetables,
Bipolaris and Drechslera species on corn, cereals, rice and lawns,
Blumeria graminis (powdery mildew) on cereals,
Botrytis cinerea (gray mold) on strawberries, vegetables, ornamental plants and grapevines,
Bremia lactucae on lettuce,
Cercospora species on corn, soybeans, rice and sugar beet,
Cochliobolus species on corn, cereals, rice (e.g., Cochliobolus sativus on cereals, Cochliobolus miyabeanus on rice),
Colletotricum species on soybeans and cotton,
Drechslera species on cereals and corn,
Exserohilum species on corn,
Erysiphe cichoracearum and Sphaerotheca fuliginea on cucurbits,
Fusarium and Verticillium species on various plants,
Gaeumanomyces graminis on cereals,
Gibberella species on cereals and rice (e.g., Gibberella fujikuroi on rice),
Grain staining complex on rice,
Helminthosporium species on corn and rice,
Michrodochium nivale on cereals,
Mycosphaerella species on cereals, bananas and peanuts,
Phakopsara pachyrhizi and Phakopsara meibomiae on soybeans,
Phomopsis species on soybeans and sunflowers,
Phytophthora infestans on potatoes and tomatoes,
Plasmopara viticola on grapevines,
Podosphaera leucotricha on apples,
Pseudocercosporella herpotrichoides on cereals,
Pseudoperonospora species on hops and cucurbits,
Puccinia species on cereals and corn,
Pyrenophora species on cereals,
Pyricularia oryzae, Corticium sasakii, Sarocladium oryzae, S. attenuatum, Entyloma oryzae on rice,
Pyricularia grisea on lawns and cereals,
Pythium spp. on lawns, rice, corn, cotton, rapeseed, sunflowers, sugar beet, vegetables and other plants,
Rhizoctonia species on cotton, rice, potatoes, lawns, corn, rapeseed, potatoes, sugar beet, vegetables and other plants,
Sclerotinia species on rapeseed and sunflowers,
Septoria tritici and Stagonospora nodorum on wheat,
Erysiphe (syn. Uncinula) necator on grapevines,
Setospaeria species on corn and lawns,
Sphacelotheca reilinia on corn,
Thievaliopsis species on soybeans and cotton,
Tilletia species on cereals,
Ustilago species on cereals, corn and sugar beet, and
Venturia species (scab) on apples and pears.

Menadione and active compounds from groups A) to O) can be applied simultaneously, that is jointly or separately, or successively, the sequence, in the case of separate application, generally not having any effect on the result of the control measures. In the case of separate application, menadione is preferably applied first.

Some of the active compounds defined at the outset are capable of forming salts or adducts with inorganic or organic acids and with metal ions, respectively. The present invention also embraces the use of the salts or adducts in question.

Menadione is preferably used as adduct of plant-compatible acid addition salts. The adducts of menadione x sodium bisulfite, nicotinamide bisulfite and dimethylpyrimidinol bisulfite are widely used and represent preferred subject matters in the present invention. In the present invention, the use of menadione×NaHSO₃ is particularly preferred.

The active compounds of groups A) to O) mentioned above as component 2, their preparation and their action against phytopathogenic harmful fungi are generally known (cf.: http://www.hclrss.demon.co.uk/index.html):
cyproconazole, 2-(4-chlorophenyl)-3-cyclopropyl-1-[1,2,4]triazol-1-ylbutan-2-ol (U.S. Pat. No. 4,664,696);
difenoconazole, 1-{2-[2-chloro-4-(4-chlorophenoxy)phenyl]-4-methyl-[1,3]dioxolan-2-ylmethyl}-1 H-[1,2,4]triazole (GB-A 2 098 607);
epoxiconazole, (2RS,3SR)-1-[3-(2-chlorophenyl)-2,3-epoxy-2-(4-fluorophenyl)propyl]-1H-1,2,4-triazole (EP-A 196 038);
fluquinconazol, 3-(2,4-dichlorophenyl)-6-fluoro-2-[1,2,4]triazol-1-yl-3H-quinazolin-4-one (Proc. Br. Crop Prot. Conf.—Pests Dis., 5-3, 411 (1992));
flusilazole, 1-{[bis-(4-fluorophenyl)methylsilanyl]methyl}-1H-[1,2,4]triazole (Proc. Br. Crop Prot. Conf.—Pests Dis., 1, 413 (1984));
hexaconazole, 2-(2,4-dichlorophenyl)-1-[1,2,4]-triazol-1-ylhexan-2-ol (CAS-RN [79983-71-4]);
imazalil, (RS)-1-(β-allyloxy-2,4-dichlorophenylethyl)imidazole [CAS RN 35554-44-0];
metconazole, 5-(4-chlorobenzyl)-2,2-dimethyl-1-[1,2,4]triazol-1-ylmethylcyclopentanol (GB 857 383);
myclobutanil, 2-(4-chlorophenyl)-2-[1,2,4]triazol-1-ylmethylpentanenitrile (CAS RN [88671-89-0]);
penconazole, 1-[2-(2,4-dichlorophenyl)pentyl]-1H-[1,2,4]triazole (Pesticide Manual, 12th Ed. (2000), page 712);
prochloraz, N-propyl-N-[2-(2,4,6-trichlorophenoxy)ethyl]imidazole-1-carboxamide (U.S. Pat. No. 3,991,071);
prothioconazole, 2-[2-(1-chlorocyclopropyl)-3-(2-chlorophenyl)-2-hydroxypropyl]-2,4-dihydro-[1,2,4]triazol-3-thione (WO 96/16048);
tebuconazole, 1-(4-chlorophenyl)-4,4-dimethyl-3-[1,2,4]triazol-1-ylmethylpentan-3-ol (EP-A 40 345);
triadimefon, 1-(4-chlorophenoxy)-3,3-dimethyl-1-(1H-1,2,4-triazol-1-yl)-2-butanone [CAS RN 43121-43-3];
triadimenol, β-(4-chlorophenoxy)-α-(1,1-dimethylethyl)-1H-1,2,4-triazol-1-ethanol [CAS RN 55219-65-3];
triflumizole, (4-chloro-2-trifluoromethylphenyl)-(2-propoxy-1-[1,2,4]triazol-1-ylethylidene)amine (JP-A 79/119 462);
azoxystrobin, methyl 2-{2-[6-(2-cyano-1-vinylpenta-1,3-dienyloxy)pyrimidin-4-yloxy]phenyl}-3-methoxyacrylate (EP-A 382 375);
dimoxystrobin, (E)-2-(methoxyimino)-N-methyl-2-[α-(2,5-xylyloxy)-o-tolyl]acetamide (EP-A 477 631);
fluoxastrobin, (E)-{2-[6-(2-chlorophenoxy)-5-fluoropyrimidin-4-yloxy]phenyl}(5,6-dihydro-1,4,2-dioxazin-3-yl)methanone O-methyloxime (WO 97/27189);
kresoxim-methyl, methyl (E)-methoxyimino[α-(o-tolyloxy)-o-tolyl]acetate (EP-A 253 213);
metominostrobin, (E)-2-(methoxyimino)-N-methyl-2-(2-phenoxyphenyl)acetamide (EP-A 398 692);
orysastrobin, (2E)-2-(methoxyimino)-2-{2-[(3E,5E,6E)-5-(methoxyimino)-4,6-dimethyl-2,8-dioxa-3,7-diazanona-3,6-dien-1-yl]phenyl}-N-methylacetamide (WO 97/15552);
picoxystrobin, methyl 3-methoxy-2-[2-(6-trifluoromethylpyridin-2-yloxymethyl)phenyl]-acrylate (EP-A 278 595);
pyraclostrobin, methyl N-{2-[1-(4-chlorophenyl)-1H-pyrazol-3-yloxymethyl]phenyl}(N-methoxy)carbamate (WO-A 96/01256);
trifloxystrobin, methyl (E)-methoxyimino-{(E)-α-[1-(α,α,α-trifluoro-m-tolyl)ethylidene-aminooxy]-o-tolyl}acetate (EP-A 460 575);
benalaxyl, methyl N-(phenylacetyl)-N-(2,6-xylyl)-DL-alaninate [CAS RN 71626-11-4],
metalaxyl-M, methyl N-(methoxyacetyl)-N-(2,6-xylyl)-DL-alaninate (GB 15 00 581);
mefenoxam, methyl N-(methoxyacetyl)-N-(2,6-xylyl)-D-alaninate (WO 96/01559);
ofurace, (RS)-α-(2-chloro-N-2,6-xylylacetamido)-y-butyrolactone [CAS RN 58810-48-3];
oxadixyl; N-(2,6-dimethylphenyl)-2-methoxy-N-(2-oxo-3-oxazolidinyl)acetamide;
spiroxamine, (8-tert-butyl-1,4-dioxaspiro[4.5]dec-2-yl)diethylamine (EP-A 281 842);
pyrimethanil, (4,6-dimethylpyrimidin-2-yl)phenylamine (DD-A 151 404);
mepanipyrim, (4-methyl-6-prop-1-ynylpyrimidin-2-yl)phenylamine (EP-A 224 339);
cyprodinil, (4-cyclopropyl-6-methylpyrimidin-2-yl)phenylamine (EP-A 310 550);
iprodione, N-isopropyl-3-(3,5-dichlorophenyl)-2,4-dioxoimidazolidine-1-carboxamide (GB 13 12 536);
procymidone, N-(3,5-dichlorophenyl)-1,2-dimethylcyclopropane-1,2-dicarboximide (U.S. Pat. No. 3,903,090);
vinclozolin, 3-(3,5-dichlorophenyl)-5-methyl-5-vinyloxazolidine-2,4-dione (DE-A 22 07 576);
dimethomorph, 3-(4-chlorophenyl)-3-(3,4-dimethoxyphenyl)-1-morpholin-4-ylpropenone (EP-A 120 321);
flumetover, 2-(3,4-dimethoxyphenyl)-N-ethyl-α,α,α-trifluoro-N-methyl-p-toluamide [CAS RN 154025-04-4];
flumorph, 3-(4-fluorophenyl)-3-(3,4-dimethoxyphenyl)-1-morpholin-4-ylpropenone (EP-A 860 438);
ferbam, iron(3+) dimethyidithiocarbamate (U.S. Pat. No. 1,972,961);
nabam, disodium ethylenebis(dithiocarbamate) (U.S. Pat. No. 2,317,765);
maneb, manganese ethylenebis(dithiocarbamate) (U.S. Pat. No. 2,504,404);
metam, methyldithiocarbamic acid (U.S. Pat. No. 2,791,605);
metiram, zinc ammoniate ethylenebis(dithiocarbamate) (U.S. Pat. No. 3,248,400);
propineb, zinc propylenebis(dithiocarbamate) polymer (BE 611 960);
polycarbamate;
thiram, bis(dimethylthiocarbamoyl) disulfide (DE 642 532);
ziram, dimethyidithiocarbamate;
zineb, zinc ethylenebis(dithiocarbamate) (U.S. Pat. No. 2,457,674);
benomyl, N-butyl-2-acetylaminobenzoimidazole-1-carboxamide (U.S. Pat. No. 3,631,176);
boscalid, 2-chloro-N-(4′-chlorobiphenyl-2-yl)nicotinamide (EP-A 545 099);
carbendazim, methyl (1H-benzoimidazol-2-yl)carbamate (U.S. Pat. No. 3,657,443);
dithianon, 5,10-dioxo-5,10-dihydronaphtho[2,3-b][1,4]dithiine-2,3-dicarbonitrile (GB 857 383);
famoxadone, (RS)-3-anilino-5-methyl-5-(4-phenoxyphenyl)-1,3-oxazolidine-2,4-dione;
fenamidone, (S)-1-anilino-4-methyl-2-methylthio-4-phenylimidazolin-5-one;
picobenzamid, 2,6-dichloro-N-(3-chloro-5-trifluoromethylpyridin-2-ylmethyl)benzamide (WO 99/42447);
proquinazid, 6-iodo-2-propoxy-3-propylquinazolin-4(3H)-one (WO 97/48684);
quinoxyfen, 5,7-dichloro4-(4-fluorophenoxy)quinoline (U.S. Pat. No. 5,240,940);
thiophanate-methyl, 1,2-phenylenebis(iminocarbonothioyl)bis(dimethylcarbamate) (DE-A 19 30 540);
triforine, N,N′-{piperazine-1,4-diylbis[(trichloromethyl)methylene]}diformamide (DE 19 01 421);
sulfur;
Bordeaux mixture is the mixture of calcium hydroxide and copper(II) sulfate;
copper acetate, copper oxychloride, basic copper sulfate;
dinocap, the mixture of 2,6-dinitro-4-octylphenyl crotonate and 2,4-dinitro-6-octylphenyl
crotonate, where “octyl” is a mixture of 1-methylheptyl, 1-ethylhexyl and 1-propylpentyl (U.S. Pat. No. 2,526,660);
fenpiclonil, 4-(2,3-dichlorophenyl)-1H-pyrrole-3-carbonitrile (Proc. 1988 Br. Crop Prot. Conf.—Pests Dis., Vol. 1, p. 65);
fludioxonil, 4-(2,2-difluorobenzo[1,3]dioxol-4-yl)-1H-pyrrole-3-carbonitrile (The Pesticide Manual, publ. The British Crop Protection Council, 10th Ed. (1995), p. 482);
captafol, N-(1,1,2,2-tetrachloroethylthio)cyclohex-4-ene-1,2-dicarboximide [CAS RN 2425-06-1];
dichlofluanid, N-dichlorofluoromethylthio-N′,N′-dimethyl-N-phenylsulfamide (DE 11 93 498);
tolylfluanid, N-dichlorofluoromethylthio-N′,N′-dimethyl-N-p-tolylsulfamide (DE 11 93 498);
benthiavalicarb, isopropyl {(S)-1-[(1R)-1-(6-fluorobenzothiazol-2-yl)ethylcarbamoyl]-2-methylpropyl}carbamate (JP-A 09/323 984);
chlorothalonil, 2,4,5,6-tetrachloroisophthalonitrile (U.S. Pat. No. 3,290,353);
cyflufenamid, (Z)-N-[α-(cyclopropylmethoxyimino)-2,3-difluoro-6-(trifluoromethyl)benzyl]-2-phenylacetamide (WO 96/19442);
diclofluanid, N-dichlorofluoromethylthio-N,N′-dimethyl-N-phenylsulfonamide (DE-A 11 93 498);
diethofencarb, isopropyl 3,4-diethoxycarbanilate [CAS RN 87130-20-9];
ethaboxam, N-(cyano-2-thienylmethyl)-4-ethyl-2-(ethylamino)-5-thiazolecarboxamide (EP-A 639 574);
fenhexamid, N-(2,3-dichloro-4-hydroxyphenyl)-1-methylcyclohexanecarboxamide (Proc. Br. Crop Prot. Conf.—Pests Dis., 1998, Vol. 2, p. 327);
fluazinam, 3-chloro-N-[3-chloro-2,6-dinitro-4-(trifluoromethyl)phenyl]-5-(trifluoromethyl)-2-pyridinamine (The Pesticide Manual, publ. The British Crop Protection Council, 10th Ed. (1995), p. 474);
iprovalicarb, isopropyl [(1S)-2-methyl-1-(1-p-tolylethylcarbamoyl)propyl]carbamate (EP-A 472 996);
mandipropamid, (RS)-2-(4-chlorophenyl)-N-[3-methoxy-4-(prop-2-ynyloxy)phenethyl]-2-(prop-2-ynyloxy)acetamide [CAS RN 374726-62-2];
metrafenone, 3′-bromo-2,3,4,6′-tetramethoxy-2′,6-dimethylbenzophenone (U.S. Pat. No. 5,945,567);
zoxamide, (RS)-3,5-dichloro-N-(3-chloro-1-ethyl-1-methyl-2-oxopropyl)-p-toluamide [CAS RN 156052-68-5].

Likewise known are the compounds, named according to IUPAC, their preparation and their fungicidal action:
methyl 2-(ortho-((2,5-dimethylphenyloxymethylene)phenyl)-3-methoxyacrylate (EP-A 226 917);
N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide (WO 03/066609);
5-chloro-7-(4-methylpiperidin-1-yl)-6-(2,4,6-trifluorophenyl)-[1,2,4]triazolo[1,5-a]pyrimidine (cf. WO 98/46607);
N,N-dimethyl-3-(3-bromo-6-fluoro-2-methylindole-1-sulfonyl)-[1,2,4]triazole-1-sulfonamide (cf. EP-A 10 31 571; JP-A 2001-192 381);
thiophene derivatives of the formula II-A (cf. JP 10130268);
oxime ether derivatives of the formula III (cf. WO 99/14188);
phenylamidine derivatives of the formula IV (cf. WO 00/46184);
compounds of the formula V (cf. WO 97/48684; WO 02/094797).

In the definitions of the symbols given for formulae II-A to V, collective terms were used which represent the following substituents:
halogen: fluorine, chlorine, bromine and iodine;
alkyl: saturated, straight-chain or branched hydrocarbon radicals having 1 to 4 carbon atoms, for example C₁-C₄-alkyl, such as methyl, ethyl, propyl, 1-methylethyl, butyl, 1-methylpropyl, 2-methylpropyl, 1,1-dimethylethyl;
haloalkyl: straight-chain or branched alkyl groups having 1 or 2 carbon atoms (mentioned above), where some or all of the hydrogen atoms in these groups may be replaced by halogen atoms as mentioned above: in particular C₁-C₂-haloalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl or 1,1,1-trifluoroprop-2-yl.

In a preferred embodiment of the invention, mixtures of menadione with 5-chloro-7-(4-methylpiperidin-1-yl)-6-(2,4,6-trifluorophenyl)-[1,2,4]triazolo[1 ,5-a]pyrimidine (compound A) are present.

In another embodiment of the invention, mixtures of menadione with at least one compound of the formula II-A are present.

In formula II-A, the following meanings of the substituents, on their own or in combination, are preferred:

Ar is preferably phenyl or a five-membered aromatic heterocycle, in particular a five-membered heteroaryl radical which is unsubstituted or substituted by one or two groups R²¹.

In addition, Ar preferably represents the following groups: phenyl, pyridine, pyrazine, furan, thiophene, pyrazole and thiazole. Particularly preferred groups Ar are: 3-pyridinyl, pyrazinyl, 3-furyl, 3-thiophenyl, 4-pyrazolyl, 5-thiazolyl.

With particular preference, a group R²¹ is located ortho to the amide grouping.

Preferred groups R²¹ are halogen, in particular chlorine, alkyl, in particular methyl, and halomethyl, in particular fluoromethyl, difluoromethyl or trifluoromethyl.

Preferred groups R are alkyl groups, in particular branched C₃-C₈-alkyl groups, especially 4-methylpent-2-yl.

The following compounds of the formula II-A are particularly suitable for the intended use in mixtures with the compound I:

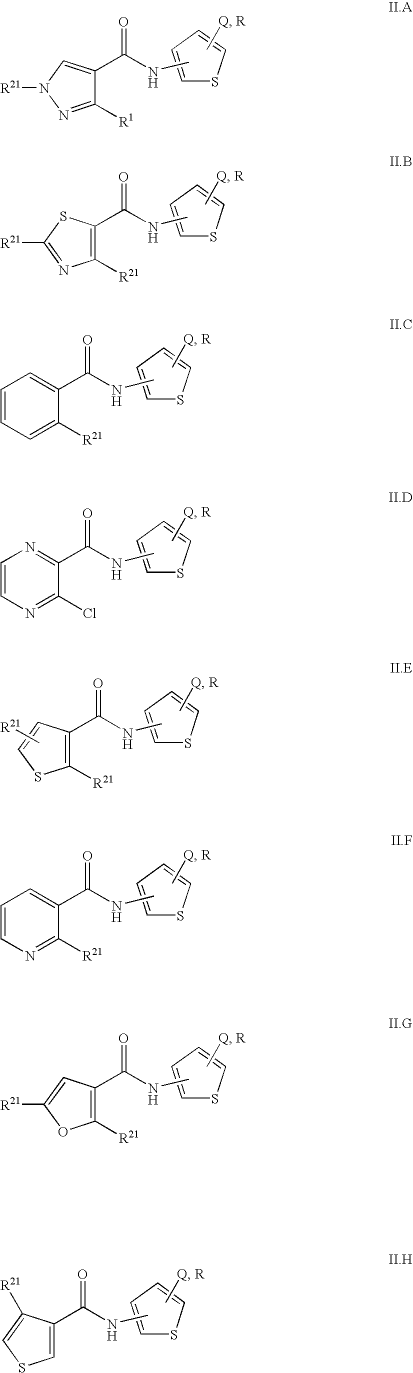

If two groups R²¹ are present in a formula, these groups can be identical or different.

Particular preference is given to compounds II.A, in particular compounds of the formulae II.A.1 and II.B.1 in which R²¹ may be identical or different and are methyl or halomethyl and R is alkyl, such as branched C₃-C₈-alkyl, in particular 4-methylpent-2-yl:

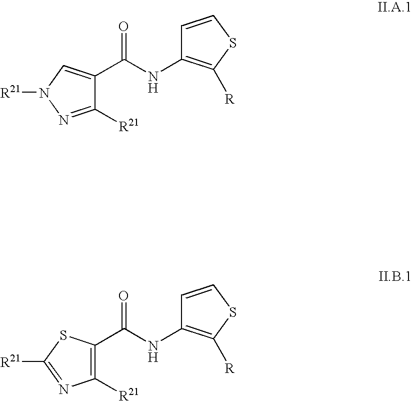

Especially preferred are compounds II.A.11 and II.B.11 which are present in the form of their R- and S-isomers:

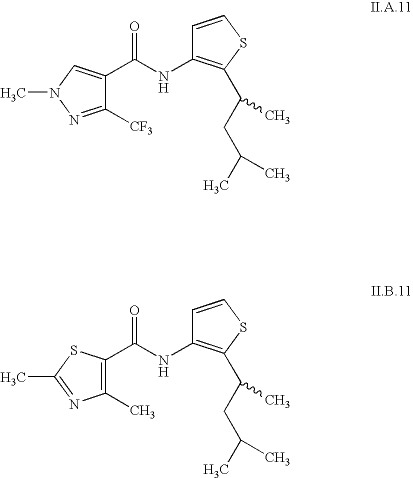

In a further embodiment of the invention, mixtures of menadione with at least one oxime ether derivative of the formula III are present.

Among the compounds of the formula III, preference is given to those in which X is a difluoromethoxy group. In addition, particular preference is given to compounds of the formula III in which the index n is zero.

Especially preferred compounds III are in particular the compounds listed in Table III below:

TABLE III

| No. | X | Rₙ |
|---|---|---|
| III-1 | OCF₃ | H |
| III-2 | OCHF₂ | H |
| III-3 | OCH₂F | H |
| III-4 | OCF₃ | 4-OCH₃ |
| III-5 | OCHF₂ | 4-OCH₃ |
| III-6 | OCH₂F | 4-OCH₃ |
| III-7 | OCF₃ | 4-F |
| III-8 | OCHF₂ | 4-F |
| III-9 | OCH₂F | 4-F |
| III-10 | OCF₃ | 4-Cl |
| III-11 | OCHF₂ | 4-Cl |
| III-12 | OCH₂F | 4-Cl |
| III-13 | OCF₃ | 4-CH₃ |
| III-14 | OCHF₂ | 4-CH₃ |
| III-15 | OCH₂F | 4-CH₃ |
| III-16 | OCF₃ | 4-CF₃ |
| III-17 | OCHF₂ | 4-CF₃ |
| III-18 | OCH₂F | 4-CF₃ |
| III-19 | OCF₃ | 4-CF₃ |

Especially preferred is the compound III-2.

In a further embodiment of the invention, mixtures of menadione with at least one compound of the formula IV are present.

With a view to the intended use of the compounds IV, particular preference is given to the following meanings of the substituents, in each case on their own or in combination:
R⁴¹ is hydrogen;
R⁴² is C₁-C₆-alkyl, such as methyl and ethyl, in particular methyl,
R⁴³ is C₁-C₆-alkyl, such as methyl and ethyl, in particular ethyl;
R⁴⁴ is C₁-C₆-alkyl, in particular methyl;
R⁴⁵ is C₁-C₆-alkyl, in particular methyl;
m is 1, where R⁴⁵ is located para to R⁴⁴;
A is oxygen (—O—);
R⁴⁶ is phenyl which is preferably unsubstituted or substituted by one to three groups R^{f}, in particular by one or two groups R^{f};
R^{f} is halogen, in particular fluorine or chlorine, alkyl, in particular methyl, ethyl, n- and isopropyl and tert-butyl, and haloalkyl, in particular trifluoromethyl.

The groups R^{f} are preferably located in the 3- or 3,4-position.

The compounds of the formula IV.A listed in Table IV below are particularly suitable for the intended use in mixtures with menadione:

TABLE IV

| | |
|---|---|
| | IV.A |
| 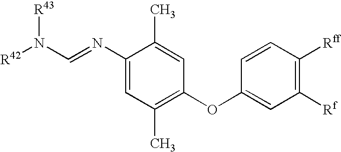 | |

| No. | R⁶² | R⁶³ | R^{f} | R^{ff} |
|---|---|---|---|---|
| IV-1 | CH₃ | CH₂CH₃ | CF₃ | Cl |
| IV-2 | CH₃ | CH₂CH₃ | CF₃ | F |
| IV-3 | CH₃ | CH₃ | CF₃ | H |
| IV-4 | CH₂CH₃ | CH₂CH₃ | CF₃ | H |
| IV-5 | CH₃ | CH₃ | C(CH₃)₃ | H |
| IV-6 | CH₂CH₃ | CH₂CH₃ | C(CH₃)₃ | H |
| IV-7 | CH₃ | CH₃ | C₆H₅—O— | H |
| IV-8 | CH₂CH₃ | CH₂CH₃ | C₆H₅—O— | H |
| IV-9 | CH₃ | CH₃ | Cl | Cl |
| IV-10 | CH₂CH₃ | CH₂CH₃ | Cl | Cl |

In another embodiment of the invention, mixtures of menadione with at least one compound of the formula V are present.

Preference is given to compounds of the formula V in which R⁵¹ is n-propyl or n-butyl, in particular n-propyl.

In addition, particular preference is given to compounds of the formula V in which R⁵³ is iodine or bromine, in particular iodine.

The formula V represents in particular compounds of the formula V.1, V.2 and V.3:

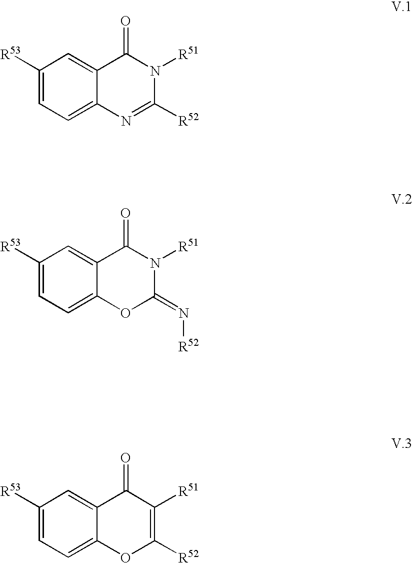

in which the variables are as defined for formula V.

The compound of the formula V.1 in which R⁵¹ is n-propyl, R⁵² is n-propoxy and R⁵³ is iodine is also known under the common name proquinazid (compound V.1-1). Mixtures of menadione and proquinazid are a preferred embodiment of the invention.

In addition, mixtures comprising the compound of the formula I and a compound of the formula V.2 are also a preferred embodiment of the invention.

Especially preferred are the mixtures with the compound I and one of the compounds of the formula V.2 below:

| No. | R⁵¹ | R⁵² | R⁵³ |
|---|---|---|---|
| V.2-1 | CH₂CH₂CH₃ | OCH₃ | I |
| V.2-2 | CH₂CH₂CH₂CH₃ | OCH₂CH₃ | I |
| V.2-3 | CH₂CH₂CH₃ | OCH₂CH₃ | I |
| V.2-4 | CH₂CH₂CH₃ | OCH(CH₃)₂ | I |

A further preferred embodiment of the invention relates to mixtures of the compound I and one of the following compounds of the formula V.3:

| No. | R⁵¹ | R⁵² | R⁵³ |
|---|---|---|---|
| V.3-1 | CH₂CH₂CH₃ | OCH₃ | I |
| V.3-2 | CH₂CH₂CH₂CH₃ | OCH₂CH₃ | I |
| V.3-3 | CH₂CH₂CH₃ | OCH₂CH₃ | I |
| V.3-4 | CH₂CH₂CH₃ | OCH(CH₃)₂ | I |
| V.3-5 | CH₂CH₂CH₃ | OCH₂CH₂CH₃ | I |
| V.3-6 | CH₂CH₂CH₃ | OCH₂CH₂CH₂CH₃ | I |
| V.3-7 | CH₂CH₂CH₃ | OCH₃ | Br |
| V.3-8 | CH₂CH₂CH₂CH₃ | OCH₂CH₃ | Br |
| V.3-9 | CH₂CH₂CH₃ | OCH₂CH₃ | Br |
| V.3-10 | CH₂CH₂CH₃ | OCH(CH₃)₂ | Br |
| V.3-11 | CH₂CH₂CH₃ | OCH₂CH₂CH₃ | Br |
| V.3-12 | CH₂CH₂CH₃ | OCH₂CH₂CH₂CH₃ | Br |

Mixtures of the compound I with compounds V.3-6 or V.3-12, in particular V.3-6, are particularly preferred here.

A further preferred embodiment of the mixtures according to the invention relates to the combination of menadione and strobilurins, such as azoxystrobin, fluoxastrobin, kresoxim-methyl, orysastrobin, picoxystrobin, pyraclostrobin or trifloxystrobin, in particular azoxystrobin, fluoxastrobin, pyraclostrobin or trifloxystrobin.

A further preferred embodiment of the mixtures according to the invention relates to the combination of menadione and acylalanines, such as benalaxyl, metalaxyl, mefenoxam, ofurace or oxadixyl.

A further preferred embodiment of the mixtures according to the invention relates to the combination of menadione and cinnamides and analogs, such as dimethomorph, flumetover or flumorph.

A further preferred embodiment of the mixtures according to the invention relates to the combination of menadione and heterocylic compounds, such as dithianon, picobenzamid, thiophanate-methyl or triforine.

A further preferred embodiment of the mixtures according to the invention relates to the combination of menadione and sulfur or copper fungicides, such as Bordeaux mixture, copper acetate, copper oxychloride, basic copper sulfate.

A further preferred embodiment of the mixtures according to the invention relates to the combination of menadione and an active compound selected from the group consisting of captafol, dichlofluanid, tolylfluanid, benthiavalicarb, chlorothalonil, cyflufenamid, diclofluanid, diethofencarb, ethaboxam, fenhexamid, fluazinam, iprovalicarb, metrafenone and zoxamide.

When preparing the mixtures, it is preferred to employ the pure active compounds I and II, to which further active compounds against harmful fungi or other pests, such as insects, arachnids or nematodes, or else herbicidal or growth-regulating active compounds or fertilizers can be added as further active components according to need.

Usually, mixtures of menadione with an active compound from groups A) to O) are employed. However, in certain cases mixtures of menadione with two or, if appropriate, more active components may be advantageous.

Suitable further active components in the above sense are in particular the active compounds, mentioned at the outset, from groups A) to O) and in particular the preferred active compounds mentioned above.

Menadione and the active compound from groups A) to O) are usually employed in a weight ratio of from 50 000:1 to 1:100, preferably from 20 000:1 to 1:1, in particular from 1000:1 to 1:10.

The further active components are, if desired, added in a ratio of from 20:1 to 1:20 to the active compound from groups A) to O).

Depending on the type of compound and the desired effect, the application rates of the mixtures according to the invention are from 50 g/ha to 5000 g/ha, preferably from 100 to 1500 g/ha, in particular from 150 to 1500 g/ha.

Correspondingly, the application rates for menadione are generally from 50 to 5000 g/ha, preferably from 100 to 2500 g/ha, in particular from 100 to 1500 g/ha.

Correspondingly, the application rates for the active compound from groups A) to O) are generally from 1 to 2000 g/ha, preferably from 10 to 900 g/ha, in particular from 40 to 500 g/ha.

In the treatment of seed, application rates of mixture are generally from 1 to 1000 g/100 kg of seed, preferably from 1 to 750 g/100 kg, in particular from 5 to 500 g/100 kg.

The method for controlling harmful fungi is carried out by the separate or joint application of menadione and the active compound II from groups A) to O) or of the mixtures of menadione and the active compound from groups A) to O) by spraying or dusting the seeds, the plants or the soils before or after sowing of the plants or before or after emergence of the plants.

In a preferred embodiment of the method according to the invention, the application of menadione and the active compound II from groups A) to O) is carried out successively; in particular, menadione is applied one to 15 days prior to the application of the active compound from groups A) to O).

The method for enhancing the fungicidal activity of synthetic active compounds is carried out by separate or joint application of menadione and the synthetic active compound pound by spraying or dusting the seeds, the plants or the soils before or after sowing of the plants or before or after emergence of the plants, in the amounts described above.

The mixtures according to the invention, or menadione and the active compound II from groups A) to O), can be converted into the customary formulations, for example solutions, emulsions, suspensions, dusts, powders, pastes and granules. The use form depends on the particular intended purpose; in each case, it should ensure a fine and even distribution of the compound according to the invention.

The formulations are prepared in a known manner, for example by extending the active compound with solvents and/or carriers, if desired using emulsifiers and dispersants. Solvents/auxiliaries suitable for this purpose are essentially:
water, aromatic solvents (for example Solvesso products, xylene), paraffins (for example mineral oil fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionogenic and anionic emulsifiers (for example polyoxyethylene fatty alcohol ethers, alkylsulfonates and arylsulfonates) and dispersants such as lignosulfite waste liquors and methylcellulose.

Suitable surfactants used are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, highly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

For the treatment of seed, the formulations in question give, after two-to-tenfold dilution, active compound concentrations of from 0.01 to 60% by weight, preferably from 0.1 to 40% by weight, in the ready-to-use preparations.

The following are examples of formulations according to the invention:

1. Products for Dilution With Water

A Water-Soluble Concentrates (SL, LS)

10 parts by weight of the active compounds are dissolved in 90 parts by weight of water or in a water-soluble solvent. As an alternative, wetters or other auxiliaries are added. The active compound dissolves upon dilution with water. In this way, a formulation having a content of 10% by weight of active compound is obtained.

B Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight.

C Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

D Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The formulation has an active compound content of 25% by weight.

E Suspensions (SC, OD, FS)

In an agitated ball mill, 20 parts by weight of the active compounds are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-Dispersible Granules and Water-Soluble Granules (WG, SG)

50 parts by weight of the active compounds are ground finely with addition of 50 parts by weight of dispersants and wetters and prepared as water-dispersible or water-soluble granules by means of technical appliances (for example extrusion, spray tower, fluidized bed). Dilution with water gives a stable-dispersion or solution of the active compound. The formulation has an active compound content of 50% by weight.

G Water-Dispersible Powders and Water-Soluble Powders (WP, SP, SS, WS)

75 parts by weight of the active compounds are ground in a rotor-stator mill with addition of 25 parts by weight of dispersants, wetters and silica gel. Dilution with water gives a stable dispersion or solution of the active compound. The active compound content of the formulation is 75% by weight.

H Gel Formulations

In a ball mill, 20 parts by weight of the active compounds, 10 parts by weight of dispersant, 1 part by weight of gelling agent and 70 parts by weight of water or an organic solvent are ground to give a fine suspension. On dilution with water, a stable suspension having an active compound content of 20% by weight is obtained.

2. Products to be Applied Undiluted

I Dustable Powders (DP, DS)

5 parts by weight of the active compounds are ground finely and mixed intimately with 95 parts by weight of finely divided kaolin. This gives a dustable product having an active compound content of 5% by weight.

J Granules (GR, FG, GG, MG)

0.5 part by weight of the active compounds is ground finely and associated with 99.5 parts by weight of carriers. Current methods are extrusion, spray-drying or the fluidized bed. This gives granules to be applied undiluted having an active compound content of 0.5% by weight.

K ULV Solutions (UL)

10 parts by weight of the active compounds are dissolved in 90 parts by weight of an organic solvent, for example xylene. This gives a product to be applied undiluted having an active compound content of 10% by weight.

For seed treatment, use is usually made of water-soluble concentrates (LS), suspensions (FS), dustable powders (DS), water-dispersible and water-soluble powders (WS, SS), emulsions (ES), emulsifiable concentrates (EC) and gel formulations (GF). These formulations can be applied to the seed in undiluted form or, preferably, diluted. Application can be carried out prior to sowing.

Preference is given to using FS formulations for seed treatment. Usually, such formulations comprise from 1 to 800 g of active compound/l, from 1 to 200 g of surfactants/l, from 0 to 200 g of antifreeze agents/l, from 0 to 400 g of binder/l, from 0 to 200 g of colorants/l and solvents, preferably water.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; they are intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. However, it is also possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Oils of various types, wetters, adjuvants, herbicides, fungicides, other pesticides, or bactericides may be added to the active compounds, even, if appropriate, not until immediately prior to use (tank mix). These agents may be admixed with the compositions according to the invention in a weight ratio of from 1:100 to 100:1, preferably from 1:10 to 10:1.

Suitable adjuvants in this sense are in particular: organically modified polysiloxanes, for example Break Thru S 240®; alcohol alkoxylates, for example Atplus 245®, Atplus MBA 1303®, Plurafac LF 300® and Lutensol ON 30®; EO/PO block polymers, for example Pluronic RPE 2035® and Genapol B®; alcohol ethoxylates, for example Lutensol XP 80®; and sodium dioctylsulfosuccinate, for example Leophen RA®.

The compounds I and II or the mixtures or the corresponding formulations are applied by treating the harmful fungi, the plants, seeds, soils, areas, materials or spaces to be kept free from them with a fungicidally effective amount of the mixture or, in the case of separate application, of the compounds I and II. Application can be carried out before or after infection by the harmful fungi.

The fungicidal effect of the compound and the mixtures is demonstrated by the following tests:

The active compounds were prepared separately as a stock solution with 0.25% by weight of active compound in acetone or DMSO. 1% by weight of the emulsifier Uniperol® EL (wetting agent having emulsifying and dispersing action based on ethoxylated alkylphenols) was added to this solution, and the mixture was diluted with water to the desired concentration.

The visually determined percentages of infected leaf areas were converted into efficacies in % of the untreated control:

The efficacy (E) is calculated as follows using Abbot's formula:
E=(1−α/β)·100

α corresponds to the fungicidal infection of the treated plants in % and

β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of active compound combinations were determined using Colby's formula (Colby, S. R. “Calculating synergistic and antagonistic responses of herbicide combinations”, Weeds, 15, 20-22, 1967) and compared with the observed efficacies.

Colby's formula:
E=x+y−x·y/100

E expected efficacy, expressed in % of the untreated control, when using the mixture of the active compounds A and B at the concentrations a and b

x efficacy, expressed in % of the untreated control, when using the active compound A at the concentration a

y efficacy, expressed in % of the untreated control, when using the active compound B at the concentration b

### USE EXAMPLE 1

### Protective Activity Against Rice Blast Caused by Pyricularia oryzae

Leaves of potted rice seedlings of the cultivar “Tai-Nong 67” were treated to runoff point with aqueous suspensions of menadione and, after 6 days, of pyraclostrobin, which suspensions had the active compound concentrations stated below. One day after the last treatment, the plants were inoculated with an aqueous spore suspension of Pyricularia oryzae. The test plants were then placed in humid chambers at 22 to 24° C. and 95 to 99% relative atmospheric humidity for 6 days. The extent of the development of the infection on the leaves was then determined visually.

| | | | | | Calculated effect |
|---|---|---|---|---|---|
| | Active | Conc. | | Observed | according to |
| No. | compound | [ppm] | Ratio | effect (%) | Colby (%) |
| 1 | — (control) | — | | 0 (100% | |
| | | | | infection) | |
| 2 | menadione (I) | 250 | | 0 | |
| 3 | pyraclostrobin | 1 | | 20 | |
| | (B8) | | | | |
| 4 | I + B8 | 250 + 1 | 250:1 | 95 | 20 |

### USE EXAMPLE 2

### Protective Activity Against Puccinia recondita on Wheat (Brown Rust of Wheat)

Wheat seedlings of the cultivar “Kanzler” in pots having a diameter of 8 cm were initially watered with 2 ml of an aqueous suspension comprising 71 mg of menadione and, 6 days later, sprayed to runoff point with a further active compound having the active compound concentration stated below. The next day, the plants were inoculated with a spore suspension of brown rust of wheat (Puccinia recondita). The plants were then placed in a chamber with high atmospheric humidity (90 to 95%) at 20 to 22° C. for 24 hours. During this time, the spores germinated and the germ tubes penetrated into the leaf tissue. The next day, the test plants were returned to the greenhouse and cultivated at temperatures between 20 and 22° C. and 65 to 70% relative atmospheric humidity for a further 7 days. The extent of the rust fungus development on the leaves was then determined visually.

| | | | | | Calculated effect |
|---|---|---|---|---|---|
| | Active | | | Observed | according to |
| No. | compound | Conc. | Ratio | effect (%) | Colby (%) |
| 5 | — | — | | 0 (100% | |
| | (control) | | | infec- | |
| | | | | tion) | |
| 6 | menadione | 3.6% | | 0 | |
| | (I) | | | | |
| 7 | compound | 4 ppm | | 25 | |
| | A* | | | | |
| 8 | I + A* | 3.6% + | 40 000:1** | 50 | 25 |
| | | 4 ppm | | | |

*5-Chloro-7-(4-methylpiperidin-1-yl)-6-(2,4,6-trifluorophenyl)-[1,2,4]triazolo[1,5-a]pyrimidine
**Amount applied to the plant: about 0.5 ml of active compound solution

### USE EXAMPLE 3

### Activity Against Net Blotch of Barley Caused by Pyrenophora teres, 6 Day Protective Application

Leaves of potted barley seedlings were sprayed to runoff point with an aqueous suspension having the concentration of active compound stated below. After 6 days, the test plants were inoculated with an aqueous spore suspension of Pyrenophora [syn. Drechslera] teres, the net blotch pathogen. The test plants were then placed in a greenhouse at temperatures between 20 and 24° C. and 95 to 100% relative atmospheric humidity. After 6 days, the extent of the development of the disease was determined visually in % infection of the total leaf area.

| | | | | | Calculated effect |
|---|---|---|---|---|---|
| | Active | Conc. | | Observed | according to |
| No. | compound | [ppm] | Ratio | effect (%) | Colby (%) |
| 9 | — (control) | — | | 0 (90% | |
| | | | | infection) | |
| 10 | menadione | 63 | | 0 | |
| | (I) | 16 | | 0 | |
| 11 | iprodione | 250 | | 22 | |
| | (F1) | | | | |
| 12 | I + F1 | 63 + 250 | 1:4 | 67 | 22 |
| 13 | I + F1 | 16 + 250 | 1:16 | 44 | 22 |

### USE EXAMPLE 4

### 6 Day Protective Activity Against Puccinia recondita on Wheat (Brown Rust of Wheat)

Leaves of potted wheat seedlings of the cultivar “Kanzler” were sprayed to runoff point with an aqueous suspension having the concentration of active compound stated below. After six days, the treated plants were inoculated with a spore suspension of brown rust of wheat (Puccinia recondite). The plants were then placed in a chamber of high atmospheric humidity (90 to 95%) at 20 to 22° C. for 24 hours. During this time, the spores germinated and the germ tubes penetrated into the leaf tissue. The next day, the test plants were returned to the greenhouse and cultivated at temperatures between 20 and 22° C. and at 65 to 70% relative atmospheric humidity for a further 7 days. The extent of the rust fungus development on the leaves was then determined visually.

| | | | | | Calculated effect |
|---|---|---|---|---|---|
| | Active | Cons. | | Observed | according to |
| No. | compound | [ppm] | Ratio | effect (%) | Colby (%) |
| 14 | — (control) | — | | 0 (80% | |
| | | | | infection) | |
| 15 | menadione (I) | 16 | | 25 | |
| | | 1 | | 0 | |
| 16 | boscalid (I2) | 63 | | 22 | |
| 17 | compound A | 63 | | 22 | |
| 18 | epoxiconazole | 1 | | 22 | |
| | (A3) | | | | |
| 19 | I + I2 | 16 + 63 | 1:4 | 50 | 25 |
| 20 | I + A | 16 + 63 | 1:4 | 88 | 72 |
| 21 | I + A3 | 1 + 1 | 1:1 | 50 | 0 |

### USE EXAMPLE 5

### Activity Against Late Blight on Tomatoes Caused by Phytophthora infestans, 6 Day Protective Treatment

Leaves of potted tomato plants were sprayed to runoff point with an aqueous suspension having the concentration of active compound stated below. After 6 days, the leaves were infected with an aqueous sporangia suspension of Phytophthora infestans. The plants were then placed in a water vapor-saturated chamber at temperatures between 18 and 20° C. After 6 days, the late blight on the untreated but infected control plants had developed to such an extent that the infection could be determined visually in %.

| | | | | | Calculated effect |
|---|---|---|---|---|---|
| | Active | Conc. | | Observed | according to |
| No. | compound | [ppm] | Ratio | effect (%) | Colby (%) |
| 22 | — (control) | — | | 0 (70% | |
| | | | | infection) | |
| 23 | menadione (I) | 63 | | 27 | |
| 24 | dimethomorph | 16 | | 37 | |
| | (G1) | | | | |
| 25 | I + G1 | 63 + 16 | 4:1 | 84 | 37 |

### USE EXAMPLE 6

### Activity Against Mildew of Wheat Caused by Erysiphe [syn. Blumeria] graminis Forma Specialis. Tritici, 6 Day Protective Application

Leaves of potted wheat seedlings of the cultivar “Kanzler” were sprayed to runoff point with an aqueous suspension having the concentration of active compound stated below. The suspension or emulsion had been prepared as described above. 6 days after the application of the active compound, the plants were dusted with spores of mildew of wheat (Erysiphe [syn. Blumeria] graminis forma specialis. tritici). The test plants were then placed in a greenhouse at temperatures between 20 and 24° C. and at 60 to 90% relative atmospheric humidity. After 7 days, the extent of the mildew development was determined visually in % infection of the total leaf area.

| | | | | | Calculated effect |
|---|---|---|---|---|---|
| | Active | Conc. | | Observed | according to |
| No. | compound | [ppm] | Ratio | effect (%) | Colby (%) |
| 26 | — (Kontrolle) | — | | 0 (90% | |
| | | | | infection) | |
| 27 | menadione (I) | 16 | | 0 | |
| 28 | metiram (H5) | 63 | | 0 | |
| 29 | metrafenone | 63 | | 67 | |
| | (O11) | | | | |
| 30 | I + H5 | 16 + 63 | 1:4 | 67 | 0 |
| 31 | I + O11 | 16 + 63 | 1:4 | 100 | 67 |

The test results show that, by virtue of the strong synergism, the combinations according to the invention are considerably more active than had been predicted using Colby's formula.

1-14. (canceled)

15. A method of enhancing the activity of agrochemicals against phytopathogenic fungi comprising,
contacting a compound of Formula I 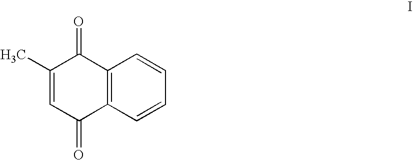
or one of its plant-compatible acid addition salts with seeds, plants or soils, said seeds, plants or soils having been, to be or simultaneously contacted with one or more agrochemicals,
wherein the activity of said agrochemicals against phytopathogenic fungi is enhanced.

16. The method of claim 15, wherein said contacting one or more compounds of Formula I is before or after sowing of said plants.

17. The method of claim 15, wherein said contacting one or more compounds of Formula I is before or after emergence of said plants.

18. The method of claim 15, wherein said contacting one or more compounds of Formula I is before or after said seeds, plants or soils have been contacted with said agrochemicals.

19. The method of claim 15, wherein said one or more agrochemicals are selected from the group consisting of:
A) azoles;
B) strobilurins;
C) acylalanines;
D) amines;
E) anilinopyrimidines;
F) dicarboximides;
G) cinnamides;
H) dithiocarbamates;
I) heterocyclic compounds;
J) thiophenes of the formula II-A, 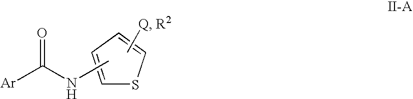
in which the variables are as defined below:
Ar is phenyl or a five- or six-membered aromatic heterocycle which contains one to four heteroatoms from the group consisting of O, N and S, where the cycles may be unsubstituted or substituted by one to three groups R²¹:
R²¹ is halogen, C₁-C₄-alkyl or C₁-C₄-haloalkyl;
R² is phenyl, C₁-C₈-alkyl, C₁-C₈-haloalkyl, C₁-C₈-alkoxy, C₁-C₈-haloalkoxy;
Q is hydrogen, C₁-C₈-alkyl, C₁-C₈-haloalkyl, C₁-C₈-alkoxy, C₁-C₈-haloalkoxy;
K) sulfur and copper fungicides;
L) nitrophenyls;
M) phenylpyrroles;
N) sulfenic acid derivatives;
O) fungicides;
P) oxime ether derivatives of the formula III, 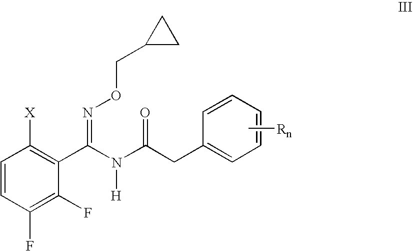
in which
X is C₁-C₄-haloalkoxy,
n is 0, 1, 2 or 3,
R is halogen, C₁-C₄-alkyl, C₁-C₄-haloalkyl, C₁-C₄-alkoxy or haloalkoxy;
Q′) phenylamidine derivatives of the formula IV, 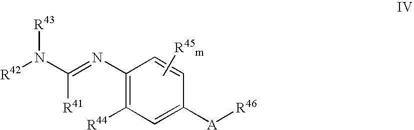
in which the variables are as defined below:
R⁴¹ is hydrogen, C₁-C₈-alkyl, C₂-C₈-alkenyl or C₂-C₃-alkynyl which are unsubstituted or may be substituted by one to three groups R^{a}:
R^{a} is halogen, C₁-C₈-alkoxy, C₁-C₈-haloalkoxy, C₁-C₈-alkylthio or
phenyl which may be substituted by halogen, C₁-C₈-alkyl, C₁-C₈-haloalkyl, C₁-C₈-alkoxy, C₁-C₈-haloalkoxy or C₁-C₈-alkylthio;
R⁴², R⁴³ may be identical or different and are hydrogen, cyano, C₁-C₈-alkyl, C₂-C₈-alkenyl, C₂-C₈-alkynyl, C₁-C₈-alkoxy, C₁-C₈-alkoxyalkyl, benzyloxy or C₁-C₈-alkylcarbonyl which are unsubstituted or may be substituted by one to three groups R^{a};
R⁴⁴ is hydrogen, C₁-C₈-alkyl, C₂-C₈-alkenyl or C₂-C₈-alkynyl which are unsubstituted or may be substituted by one to three groups R^{b}:
R^{b} is one of the groups mentioned under R^{a}, cyano, C(═O)R^{c}, C(═S)R^{c} or S(O)ₚR^{c},
R^{c} is C₁-C₈-alkyl, C₁-C₈-haloalkyl, C₁-C₈-alkoxy, C₁-C₈-haloalkoxy, C₁-C₈-alkylthio, amino, C₁-C₈-alkylamino, di(C₁-C₈-alkyl)amino or
phenyl which may be substituted by halogen, C₁-C₈-alkyl, C₁-C₈-haloalkyl, C₁-C₈-alkoxy, C₁-C₈-haloalkoxy or C₁-C₈-alkylthio;
m is 0 or 1;
R⁴⁵ is one of the groups mentioned under R⁴⁴;
A is a direct bond, —O—, —S—, NR^{d}, CHR^{e} or —O—CHR^{e};
R^{d}, R^{e} are one of the groups mentioned under R^{a};
R⁴⁶ is phenyl or a five- or six-membered saturated, partially unsaturated or aromatic heterocycle which contains one to four heteroatoms from the group consisting of O, N and S, where the groups R⁴⁶ are unsubstituted or may be substituted by one to three R^{f}:
R^{f} is one of the groups mentioned under R^{b} or amino, C₁-C₈-alkylamino, di(C₁-C₈-alkyl)amino, C₁-C₈-haloalkyl, C₁-C₈-alkoxyalkyl, C₂-C₈-alkenyloxyalkyl, C₂-C₈-alkynyloxyalkyl, C₁-C₈-alkylcarbonyloxy-C₁-C₈-alkyl, cyanooxy-C₁-C₈-alkyl, C₃-C₆-cycloalkyl or phenoxy, where the cyclic groups may be substituted by halogen, C₁-C₈-alkyl, C₁-C₈-haloalkyl, C₁-C₈-alkoxy, C₁-C₈-haloalkoxy or C₁-C₈-alkylthio;
and
R′) compounds of the formula V 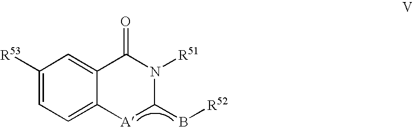
in which the variables are as defined below:
A′ is O or N;
B is N or a direct bond;
R⁵¹ is C₁-C₄-alkyl;
R⁵² is C₁-C₄-alkoxy; and
R53 is halogen.

20. The method of claim 19, wherein said:
A) azoles are selected from the group consisting of cyproconazole, difenoconazole, epoxiconazole, fluquinconazole, flusilazole, hexaconazole, imazalil, metconazole, myclobutanil, penconazole, prochloraz, prothioconazole, tebuconazole, triademefon, triademonol, and triflumizole;
B) strobilurins are selected from the group consisting of azoxystrobin, dimoxystrobin, fluoxastrobin, kresoxim-methyl, metominostrobin, orysastrobin, picoxystrobin, pyraclostrobin, trifloxystrobin and methyl 2-(ortho-((2,5-dimethylphenyloxymethylene)phenyl)-3-methoxyacrylate;
C) acylalanines are selected from the group consisting of benalaxyl, metalaxyl, mefenoxam, ofurace and oxadixyl;
D) amine is spiroxamine;
E) anilinopyrimidines are selected from the group consisting of pyrimethanil, mepanipyrim and cyprodinil;
F) dicarboximides are selected from the group consisting of iprodione, procymidone and vinclozolin;
G) cinnamides are selected from the group consisting of dimethomorph, flumetover and flumorph;
H) dithiocarbamates are selected from the group consisting of ferbam, nabam, maneb, metam, metiram, propineb, polycarbamate, thiram, ziram and zineb;
I) heterocyclic compounds are selected from the group consisting of benomyl, boscalid, carbendazim, dithianon, famoxadone, fenamidone, picobenzamid, proquinazid, quinoxyfen, thiophanate-methyl, triforine, N-(4′-bromobiphenyl-2-yl)-(4-difluoromethyl-2-methylthiazole-5-carboxamide; N-(4′-trifluoromethylbiphenyl-2-yl)-4-difluoromethyl-2-methylthiazole-5-carboxamide; N-(4′-chloro-3′-fluorobiphenyl-2-yl)-4-difluoromethyl-2-methylthiazole-5-carboxamide; N-(3′,4′-dichloro-4-fluorobiphenyl-2-yl)-3-difluoromethyl-1-methylpyrazole-4-carboxamide; 5-chloro-7-(4-methylpiperidin-1-yl)-6-(2,4,6-trifluorophenyl)-[1,2,4]triazolo[1,5-a]pyrimidine and N,N-dimethyl-3-(3-bromo-6-fluoro-2-methylindole-1-sulfonyl)-[1,2,4]triazole-1-sulfonamide;
K) sulfur and copper fungicides are selected from the group consisting of Bordeaux mixture, copper acetate, copper oxychloride and basic copper sulfate;
L) nitrophenyl is dinocap;
M) phenylpyrroles are selected from the group consisting of fenpiclonil and fludioxonil;
N) sulfenic acid are selected from the group consisting of captafol, dichlofluanid and tolylfluanid;
and
O) fungicides are selected from the group consisting of benthiavalicarb, chlorothalonil, cyflufenamid, diclofluanid, diethofencarb, ethaboxam, fenhexamid, fluazinam, iprovalicarb, mandipropamid, metrafenone and zoxamide.

21. A fungicidal mixture for controlling phytopathogenic harmful fungi comprising,
1) a compound of Formula I 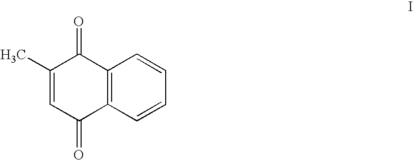
or one of its plant-compatible acid addition salts,
and
2) one or more of compound II selected from the following groups:
A) azoles;
B) strobilurins;
C) acylalanines;
D) amines;
E) anilinopyrimidines;
F) dicarboximides;
G) cinnamides;
H) dithiocarbamates;
I) heterocyclic compounds;
J) thiophenes of the formula II-A, 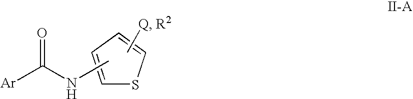
in which the variables are as defined below:
Ar is phenyl or a five- or six-membered aromatic heterocycle which contains one to four heteroatoms from the group consisting of O, N and S, where the cycles may be unsubstituted or substituted by one to three groups R²¹:
R²¹ is halogen, C₁-C₄-alkyl or C₁-C₄-haloalkyl;
R² is phenyl, C₁-C₈-alkyl, C₁-C₈-haloalkyl, C₁-C₈-alkoxy, C₁-C₈-haloalkoxy;
Q is hydrogen, C₁-C₈-alkyl, C₁-C₈-haloalkyl, C₁-C₈-alkoxy, C₁-C₈-haloalkoxy;
K) sulfur and copper fungicides;
L) nitrophenyls;
M) phenylpyrroles;
N) sulfenic acid derivatives;
O) fungicides;
P) oxime ether derivatives of the formula III, 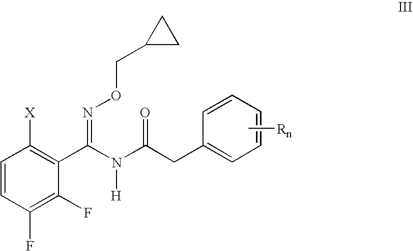
in which
X is C₁-C₄-haloalkoxy,
n is 0, 1, 2 or 3,
R is halogen, C₁-C₄-alkyl, C₁-C₄-haloalkyl, C₁-C₄-alkoxy or haloalkoxy; and
Q′) phenylamidine derivatives of the formula IV, 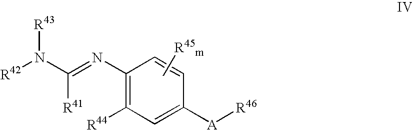
in which the variables are as defined below:
R⁴¹ is hydrogen, C₁-C₈-alkyl, C₂-C₈-alkenyl or C₂-C₈-alkynyl which are unsubstituted or may be substituted by one to three groups R^{a}:
R^{a} is halogen, C₁-C₈-alkoxy, C₁-C₈-haloalkoxy, C₁-C₈-alkylthio or
phenyl which may be substituted by halogen, C₁-C₈-alkyl, C₁-C₈-haloalkyl, C₁-C₈-alkoxy, C₁-C₈-haloalkoxy or C₁-C₈-alkylthio;
R⁴², R⁴³ may be identical or different and are hydrogen, cyano, C₁-C₈-alkyl, C₂-C₈-alkenyl, C₂-C₈-alkynyl, C₁-C₈-alkoxy, C₁-C₈-alkoxyalkyl, benzyloxy or C₁-C₈-alkylcarbonyl which are unsubstituted or may be substituted by one to three groups R^{a};
R⁴⁴ is hydrogen, C₁-C₈-alkyl, C₂-C₈-alkenyl or C₂-C₈-alkynyl which are unsubstituted or may be substituted by one to three groups R^{b}:
R^{b} is one of the groups mentioned under R^{a}, cyano, C(═O)R^{c}, C(═S)R^{c} or S(O)ₚR^{c},
R^{c} is C₁-C₈-alkyl, C₁-C₈-haloalkyl, C₁-C₈-alkoxy, C₁-C₈-haloalkoxy, C₁-C₈-alkylthio, amino, C₁-C₈-alkylamino, di(C₁-C₈-alkyl)amino or
phenyl which may be substituted by halogen, C₁-C₈-alkyl, C₁-C₈-haloalkyl, C₁-C₈-alkoxy, C₁-C₈-haloalkoxy or C₁-C₈-alkylthio;
m is 0 or 1;
R⁴⁵ is one of the groups mentioned under R⁴⁴;
A is a direct bond, —O—, —S—, NR^{d}, CHR^{e} or —O—CHR^{e};
R^{d}, R^{e} are one of the groups mentioned under R^{a};
R⁴⁶ is phenyl or a five- or six-membered saturated, partially unsaturated or aromatic heterocycle which contains one to four heteroatoms from the group consisting of O, N and S, where the groups R⁴⁶ are unsubstituted or may be substituted by one to three R^{f}:
R^{f} is one of the groups mentioned under R^{b} or amino, C₁-C₈-alkylamino, di(C₁-C₈-alkyl)amino, C₁-C₈-haloalkyl, C₁-C₈-alkoxyalkyl, C₂-C₈-alkenyloxyalkyl, C₂-C₈-alkynyloxyalkyl, C₁-C₈-alkylcarbonyloxy-C₁-C₈-alkyl, cyanooxy-C₁-C₈-alkyl, C₃-C₆-cycloalkyl or phenoxy, where the cyclic groups may be substituted by halogen, C₁-C₈-alkyl, C₁-C₈-haloalkyl, C₁-C₈-alkoxy, C₁-C₈-haloalkoxy or C₁-C₈-alkylthio;
and
R′) compounds of the formula V 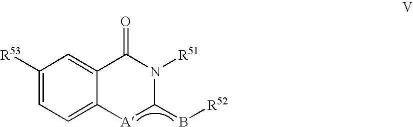
in which the variables are as defined below:
A′ is O or N;
B is N or a direct bond;
R⁵¹ is C₁-C₄-alkyl;
R⁵² is C₁-C₄-alkoxy; and
R⁵³ is halogen;
in a synergistically effective amount.

22. The fungicidal mixture of claim 21, comprising, as component 2) one or more compounds selected from the following groups:
A) azoles are selected from the group consisting of cyproconazole, difenoconazole, epoxiconazole, fluquinconazole, flusilazole, hexaconazole, imazalil, metconazole, myclobutanil, penconazole, prochloraz, prothioconazole, tebuconazole, triademefon, triademonol, and triflumizole;
B) strobilurins are selected from the group consisting of azoxystrobin, dimoxystrobin, fluoxastrobin, kresoxim-methyl, metominostrobin, orysastrobin, picoxystrobin, pyraclostrobin, trifloxystrobin and methyl 2-(ortho-((2,5-dimethylphenyloxymethylene)phenyl)-3-methoxyacrylate;
C) acylalanines are selected from the group consisting of benalaxyl, metalaxyl, mefenoxam, ofurace and oxadixyl;
D) amine is spiroxamine;
E) anilinopyrimidines are selected from the group consisting of pyrimethanil, mepanipyrim and cyprodinil;
F) dicarboximides are selected from the group consisting of iprodione, procymidone and vinclozolin;
G) cinnamides are selected from the group consisting of dimethomorph, flumetover and flumorph;
H) dithiocarbamates are selected from the group consisting of ferbam, nabam, maneb, metam, metiram, propineb, polycarbamate, thiram, ziram and zineb;
I) heterocyclic compounds are selected from the group consisting of benomyl, boscalid, carbendazim, dithianon, famoxadone, fenamidone, picobenzamid, proquinazid, quinoxyfen, thiophanate-methyl, triforine, N-(4′-bromobiphenyl-2-yl)-(4-difluoromethyl-2-methylthiazole-5-carboxamide; N-(4′-trifluoromethylbiphenyl-2-yl)-4-difluoromethyl-2-methylthiazole-5-carboxamide; N-(4′-chloro-3′-fluorobiphenyl-2-yl)-4-difluoromethyl-2-methylthiazole-5-carboxamide; N-(3′,4′-dichloro-4-fluorobiphenyl-2-yl)-3-difluoromethyl-1-methylpyrazole-4-carboxamide; 5-chloro-7-(4-methylpiperidin-1-yl )-6-(2,4,6-trifluorophenyl)-[1,2,4]triazolo[1,5-a]pyrimidine and N,N-dimethyl-3-(3-bromo-6-fluoro-2-methylindole-1-sulfonyl)-[1,2,4]triazole-1-sulfonamide;
K) sulfur and copper fungicides are selected from the group consisting of Bordeaux mixture, copper acetate, copper oxychloride and basic copper sulfate;
L) nitrophenyl is dinocap;
M) phenylpyrroles are selected from the group consisting of fenpiclonil and fludioxonil;
N) sulfenic acid are selected from the group consisting of captafol, dichlofluanid and tolylfluanid;
and
O) fungicides are selected from the group consisting of benthiavalicarb, chlorothalonil, cyflufenamid, diclofluanid, diethofencarb, ethaboxam, fenhexamid, fluazinam, iprovalicarb, mandipropamid, metrafenone and zoxamide.

23. The fungicidal mixture of claim 21, comprising, as component 1, menadione×NaHSO₃.

24. The fungicidal mixture of claim 21, comprising menadione and two compounds from groups A) to R′).

25. The fungicidal mixture of claim 21, comprising menadione and a compound II in a weight ratio of from 100:1 to 1:100.

26. A composition, comprising a liquid or solid carrier and said mixture of claim 21.

27. A method for controlling phytopathogenic fungi, which comprises contacting said fungi, their habitat or the plants to be protected against fungal attack, the soil or seed with an effective amount of a compound of Formula I 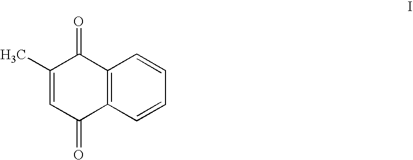
or one of its plant-compatible acid addition salts,
and
2) at least one compound II selected from the following groups:
A) azoles;
B) strobilurins;
C) acylalanines;
D) amines;
E) anilinopyrimidines;
F) dicarboximides;
G) cinnamides;
H) dithiocarbamates;
I) heterocyclic compounds;
J) thiophenes of the formula II-A, 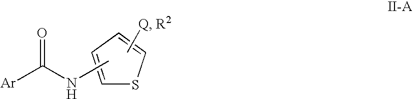
in which the variables are as defined below:
Ar is phenyl or a five- or six-membered aromatic heterocycle which contains one to four heteroatoms from the group consisting of O, N and S, where the cycles may be unsubstituted or substituted by one to three groups R²¹:
R²¹ is halogen, C₁-C₄-alkyl or C₁-C₄-haloalkyl;
R² is phenyl, C₁-C₈-alkyl, C₁-C₈-haloalkyl, C₁-C₈-alkoxy, C₁-C₈-haloalkoxy;
Q is hydrogen, C₁-C₈-alkyl, C₁-C₈-haloalkyl, C₁-C₈-alkoxy, C₁-C₈-haloalkoxy;
K) sulfur and copper fungicides;
L) nitrophenyls;
M) phenylpyrroles;
N) sulfenic acid derivatives;
O) fungicides;
P) oxime ether derivatives of the formula III, 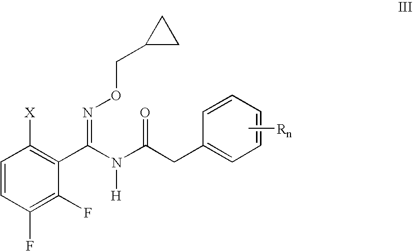
in which
X is C₁-C₄-haloalkoxy,
n is 0, 1, 2 or 3,
R is halogen, C₁-C₄-alkyl, C₁-C₄-haloalkyl, C₁-C₄-alkoxy or haloalkoxy;
Q′) phenylamidine derivatives of the formula IV, 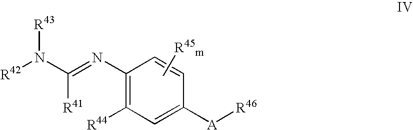
in which the variables are as defined below:
R⁴¹ is hydrogen, C₁-C₈-alkyl, C₂-C₈-alkenyl or C₂-C₃-alkynyl which are unsubstituted or may be substituted by one to three groups R^{a}:
R^{a} is halogen, C₁-C₈-alkoxy, C₁-C₈-haloalkoxy, C₁-C₈-alkylthio or
phenyl which maybe substituted by halogene C₁-C₈-alkyl, C₁-C₈-haloalkyl, C₁-C₈-alkoxy, C₁-C₈-haloalkoxy or C₁-C₈-alkylthio;
R⁴², R⁴³ may be identical or different and are hydrogen, cyano, C₁-C₈-alkyl, C₂-C₈-alkenyl, C₂-C₈-alkynyl, C₁-C₈-alkoxy, C₁-C₈-alkoxyalkyl, benzyloxy or C₁-C₈-alkylcarbonyl which are unsubstituted or may be substituted by one to three groups R^{a};
R⁴⁴ is hydrogen, C₁-C₈-alkyl, C₂-C₈-alkenyl or C₂-C₈-alkynyl which are unsubstituted or may be substituted by one to three groups R^{b}:
R^{b} is one of the groups mentioned under R^{a}, cyano, C(═O)R^{c}, C(═S)R^{c} or S(O)ₚR^{c},
R^{c} is C₁-C₈-alkyl, C₁-C₈-haloalkyl, C₁-C₈-alkoxy, C₁-C₈-haloalkoxy, C₁-C₈-alkylthio, amino, C₁-C₈-alkylamino, di(C₁-C₈-alkyl)amino or
phenyl which may be substituted by halogen, C₁-C₈-alkyl, C₁-C₈-haloalkyl, C₁-C₈-alkoxy, C₁-C₈-haloalkoxy or C₁-C₈-alkylthio;
m is 0 or 1;
R⁴⁵ is one of the groups mentioned under R⁴⁴;
A is a direct bond, —O—, —S—, NR^{d}, CHR^{e} or —O—CHR^{e};
R^{d}, R^{e} are one of the groups mentioned under R^{a};
R⁴⁶ is phenyl or a five- or six-membered saturated, partially unsaturated or aromatic heterocycle which contains one to four heteroatoms from the group consisting of O, N and S, where the groups R⁴⁶ are unsubstituted or may be substituted by one to three R^{f}:
R^{f} is one of the groups mentioned under R^{b} or amino, C₁-C₈-alkylamino, di(C₁-C₈-alkyl)amino, C₁-C₈-haloalkyl, C₁-C₈-alkoxyalkyl, C₂-C₈-alkenyloxyalkyl, C₂-C₈-alkynyloxyalkyl, C₁-C₈-alkylcarbonyloxy-C₁-C₈-alkyl, cyanooxy-C₁-C₈-alkyl, C₃-C₆-cycloalkyl or phenoxy, where the cyclic groups may be substituted by halogen, C₁-C₈-alkyl, C₁-C₈-haloalkyl, C₁-C₈-alkoxy, C₁-C₈-haloalkoxy or C₁-C₈-alkylthio;
and
R′) compounds of the formula V 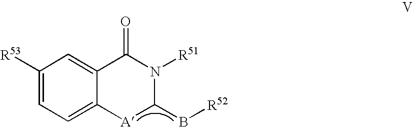
in which the variables are as defined below:
A′ is O or N;
B is N or a direct bond;
R⁵¹ is C₁-C₄-alkyl;
R⁵² is C₁-C₄-alkoxy; and
R⁵³ is halogen.

28. The method of claim 27, wherein said compound of Formula I and said compound(s) from groups A) to R′) are applied simultaneously, that is jointly or separately, or successively.

29. The method of claim 27, wherein said compound of Formula I and said compound(s) from groups A) to R′) are applied successively.

30. The method of claim 27, wherein said compound of Formula I and said compound(s) from groups A) to R′) are applied in an amount of from about 5 g/ha to about 2000 g/ha.

31. The method of claim 27, wherein said compound of Formula I and said compound(s) from groups A) to R′) are applied in an amount of from about 1 to about 1000 g/100 kg of seed.

32. Seed, comprising said mixture of claim 21 in an amount of from about 1 to about 1000 g/100 kg.

33. A method for controlling phytopathogenic fungi, comprising applying said mixture of claim 21 at an amount of from about 5 g/ha to about 2000 g/ha.

34. A method for controlling phytopathogenic fungi, comprising applying said mixture of claim 21 at an amount of from about 1 to about 1000 g/100 kg of seed.
